(19) United States
(12) Patent Application Publication
(10) Pub. No.: US 2007/0236707 A1
(43) Pub. Date: Oct. 11, 2007

(54) Image processing apparatus, image processing method and image processing program

(75) Inventor: Hirokazu Shoda, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/399,006

(22) Filed: Apr. 6, 2006

(51) Int. Cl. G06K 15/02

(52) U.S. Cl. 358/1.2; 358/1.9

(57) ABSTRACT

To provide a technology that can contribute to realization of both of reproduction of a fine line in low density and reduction of noise at an outline portion of a patch area of a uniform density, which could not be consistent in the related art. A reducing unit for executing a reducing process for reducing the resolution of an image in image data to be processed; a histogram generating unit for generating a histogram of a color space signal in a pixel area of M rows×N columns (here M, N are one or larger integers) in the image on which the reducing process is applied by the reducing unit; and a binarizing unit for executing a binarizing process on a pixel in the image on which the reducing process is applied by the reducing unit on the basis of the histogram generated in the histogram generating unit are provided.

### BACKGROUND OF THE INVENTION

1. Field of the Invention

The present invention relates to an image processing technology and, more specifically, to a determination process for determining a fine line portion from other portions in an image.

2. Description of the Related Art

An MTF (Modulation Transfer Function) correcting process in the related art realizes improvement of sharpness and reduction of roughness by switching an exaggeration filter, a smoothing filter, and omission of process according to the edge strength and the extent of roughness as shown in JP-A-10-28225.

However, when using only the edge strength and the extent of roughness as parameters, characters written with a pencil or a uniform patch of low density is all processed by the smoothing filter, and hence there is a problem such that reproduction of the characters written with the pencil is too low in density. An outline of the patch of a uniform density on a white base is a portion where the density is changed from the white base to the uniform density, and hence has the same edge strength as the character. Therefore, the process by the exaggeration filter is executed and hence the outline portion is exaggerated, which results in a noise image.

### SUMMARY OF THE INVENTION

In order to solve the above-described problems, an object of the present invention is to provide a technology that can contribute to realization of both of reproduction of a fine line in low density and reduction of noise at an outline portion of a patch area of a uniform density, which could not be consistent in the related art.

In order to solve the above-described problems, an image processing apparatus according to the present invention includes a reducing unit for executing a reducing process for reducing the resolution of an image in image data to be processed; a histogram generating unit for generating a histogram of a color space signal in a pixel area of M rows×N columns (here M, N are one or larger integers) in the image on which the reducing process is applied by the reducing unit; and a binarizing unit for executing a binarizing process on a pixel in the image on which the reducing process is applied by the reducing unit on the basis of the histogram generated by the histogram generating unit.

An image processing method according to the present invention includes a reducing step for executing a reducing process for reducing the resolution of an image in image data to be processed; a histogram generating step for generating a histogram of a color space signal in a pixel area of M rows×N columns (here M, N are one or larger integers) in the image on which the reducing process is applied in the reducing step; and a binarizing step for executing a binarizing process on a pixel in the image on which the reducing process is applied in the reducing step on the basis of the histogram generated in the histogram generating step.

An image processing program according to the present invention causes a computer to execute a reducing step for executing a reducing process for reducing the resolution of an image in image data to be processed; a histogram generating step for generating a histogram of a color space signal in a pixel area of M rows×N columns (here M, N are one or larger integers) in the image on which the reducing process is applied in the reducing step; and a binarizing step for executing a binarizing process on a pixel in the image on which the reducing process is applied in the reducing step on the basis of the histogram generated in the histogram generating step.

### DESCRIPTION OF THE DRAWINGS

FIG. 1 is a general schematic drawing for explaining an image processing apparatus according to a first embodiment of the present invention;

FIG. 2 is a drawing showing a configuration of a scanner unit A;

FIG. 3 is a drawing showing a configuration of an image processing board 14;

FIG. 4 is a drawing showing a configuration of a filtering unit;

FIG. 5 is a drawing showing a relation between a value of an identification signal DSC1 and selection of a filter;

FIG. 6 is a drawing showing an identification signal DSC2 and contents of operations of respective processes;

FIG. 7 is a drawing showing a structure of an identification unit 35;

FIG. 8 is a drawing showing an example of an edge detection matrix;

FIG. 9 is a drawing showing an arithmetic expression for calculating a color hue signal and a saturation signal;

FIG. 10 is a drawing showing a concept of the color hue signal;

FIG. 11 is a drawing showing a relation between a brightness segment and a weighted average coefficient;

FIG. 12 is a drawing showing a histogram distribution;

FIG. 13 is a drawing showing the histogram distribution;

FIG. 14 is a drawing showing the histogram distribution;

FIG. 15 is a drawing for explaining a binarizing process on a character image;

FIG. 16 is a drawing for explaining the binarizing process on the character image;

FIG. 17 is a drawing for explaining the binarizing process on the character image;

FIG. 18 is a drawing for explaining the binarizing process on a patch image of a uniform density;

FIG. 19 is a drawing for explaining the binarizing process on the patch image of a uniform density;

FIG. 20 is a drawing for explaining the binarizing process on the patch image of a uniform density;

FIG. 21 is a drawing for explaining extraction of a pixel area of the patch image of a uniform density;

FIG. 22 is a drawing for explaining the extraction of the pixel area of the patch image of a uniform density;

FIG. 23 is a drawing showing a table for generating the DSC1 signal;

FIG. 24 is a drawing showing a table for generating the DSC2 signal;

FIG. 25 is a drawing for explaining a reduction ratio and a relation between a reference range and a line width;

FIG. 26 is a drawing for explaining detectable line widths;

FIG. 27 is a drawing showing an example of filter frequency characteristics;

FIG. 28 is a drawing showing RGB signal values of a character written with a pencil;

FIG. 29 is a drawing showing a configuration of the image processing board according to a second embodiment of the present invention;

FIG. 30 is a drawing showing a configuration of an identification unit 152;

FIG. 31 is a drawing showing a table for generating a DSC3 signal;

FIG. 32 is a drawing showing a configuration of a line-thinning unit 151;

FIG. 33 is a drawing showing a table used in signal conversion in a line-thinning process;

FIG. 34 is a drawing showing a structure of the image processing board according to a third embodiment of the present invention;

FIG. 35 is a drawing showing frequency characteristics for a printed character;

FIG. 36 is a drawing showing the frequency characteristics for the character written with the pencil;

FIG. 37 is a drawing for explaining effects of the respective embodiments of the present invention;

FIG. 38 is a drawing for explaining the effects of the respective embodiments of the present invention; and

FIG. 39 is a flowchart showing roughly a flow of an image processing method according to the embodiment of the present invention.

### DESCRIPTION OF THE EMBODIMENTS

Referring now to the drawings, embodiments of the present invention will be described.

### First Embodiment

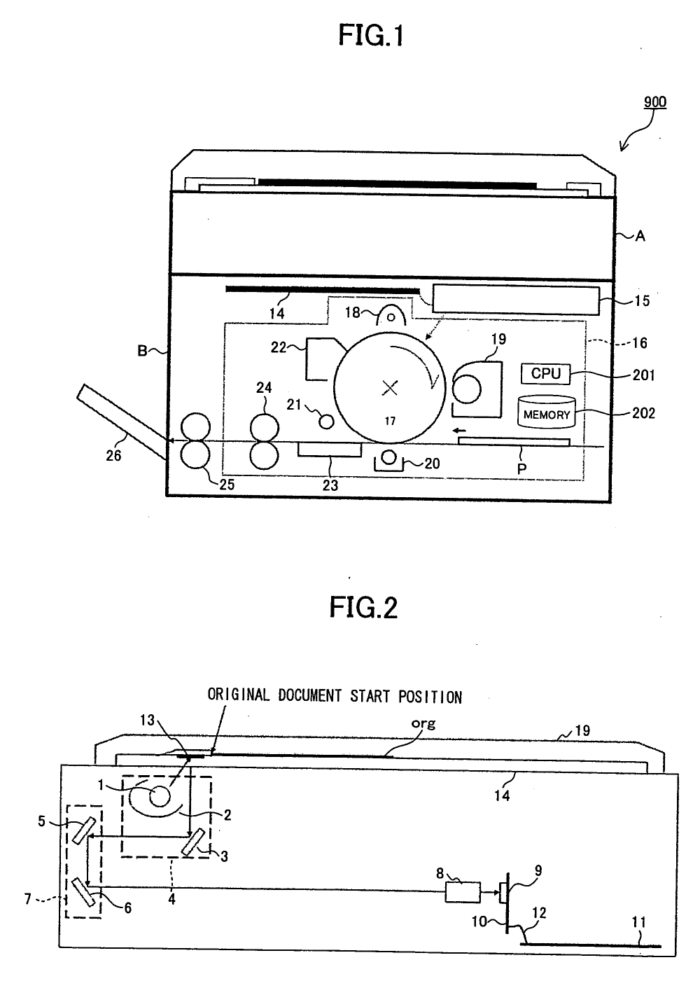

FIG. 1 is a general schematic drawing for explaining an image processing apparatus according to a first embodiment of the present invention. The image processing apparatus according to this embodiment is composed, for example of an MFP (Multi Function Peripheral). As shown in FIG. 1, the image processing apparatus 900 according to the present embodiment is composed of a scanner unit A for executing an image reading process and a printer unit B for performing an image forming process including an image processing board 14.

The scanner unit A has a structure shown in FIG. 2, and an original document org is placed on a document table glass 14 with a front face down, and the original document org is pressed against the document table glass 14 by closing a cover 19 for fixing the original document provided so as to be capable of opening and closing.

The original document org is irradiated by a light source 1, and a reflected light from the original document org is formed into an image on a sensor surface of a CCD line sensor 9 mounted to a CCD sensor board 10 via a first mirror 3, a second mirror 5, a third mirror 6, and a light-collecting lens 8. The original document org is scanned by an irradiating light from the light source 1 by the movement of a first carriage 4 composed of the light source 1 and the first mirror 3, and a second carriage 7 composed of the second mirror 5 and the third mirror 6 moved by a carriage drive motor, not shown. The movement speed of the first carriage 4 is set to double the movement speed of the second carriage 7, so that the length of an optical path from the original document org to the CCD line sensor 9 becomes constant.

The original document org placed on the document glass 14 in this manner is read in sequence line by line and is converted into an analogue electric signal according to the strength of a light signal as the reflected light by the CCD line sensor 9. Then, on a control board 11 that converts the converted analogue electric signal into the digital signal and treats a CCD-sensor-related control signal via a harness 12, a shading (distortion) correction for correcting a low-frequency distortion by the light-collecting lens 8 or a high-frequency distortion generated by fluctuation in sensitivity of the CCD line sensor 9 is applied. The process to convert the analogue electric signal into the digital signal may be executed by the CCD sensor board 10 or by the control board 11 connected via the harness 12.

When executing the above-described shading correction, a signal which is a criteria of black and a signal which is a criteria of white are necessary, and the former black criteria signal is an output signal from the CCD line sensor 9 in a state in which no light is irradiated on the CCD line sensor 9 with the light source 1 OFF, and the latter white criteria signal is an output signal from the CCD line sensor 9 in a case in which a white reference board 13 is read with the light source 1 ON. When generating the reference signals, the signals for a plurality of lines are generally averaged for reducing an influence of discriminating points or quantization error.

Since the CCD line sensor 9 is such that the respective line sensors for R, G and B are arranged physically apart from each other, the reading positions of respective line sensors are misaligned. The control board 11 corrects the misalignment of reading positions. In addition, the process such as LOG conversion is performed, and the image data is transmitted to the image processing board 14 shown in FIG. 1. The configuration of the image processing board 14 will be described later.

The printer unit B forms a latent image of the image data outputted from the image processing board 14 on a photoreceptor drum 17 by a laser optical system unit 15. An image forming unit 16 includes the photoreceptor drum 17 and a charger 18 required for generating an image by a electrophotographic process, a developing machine 19, a transfer charger 20, a separation charger 21, a cleaner 22, a paper carrier mechanism 23 for carrying a paper P, and a fixer 24. The paper P on which an image is formed by the image forming unit 16 is outputted to a paper discharge tray 26 via a discharge roller 25 for discharging the paper P to the outside of the machine.

In this arrangement, the latent images in respective colors C, M, Y and K are formed on the photoreceptor drum 17 and are transferred to the paper P, so that the image formation is achieved.

The image processing apparatus 900 is provided with a CPU 201 and a MEMORY 202. The CPU 201 has a role to perform various processes in the image processing apparatus, and also a role to achieve various functions by executing programs stored in the MEMORY 202. The MEMORY 202 is composed of, for example, a ROM or a RAM, and has a role to store various information or programs used in the image processing apparatus.

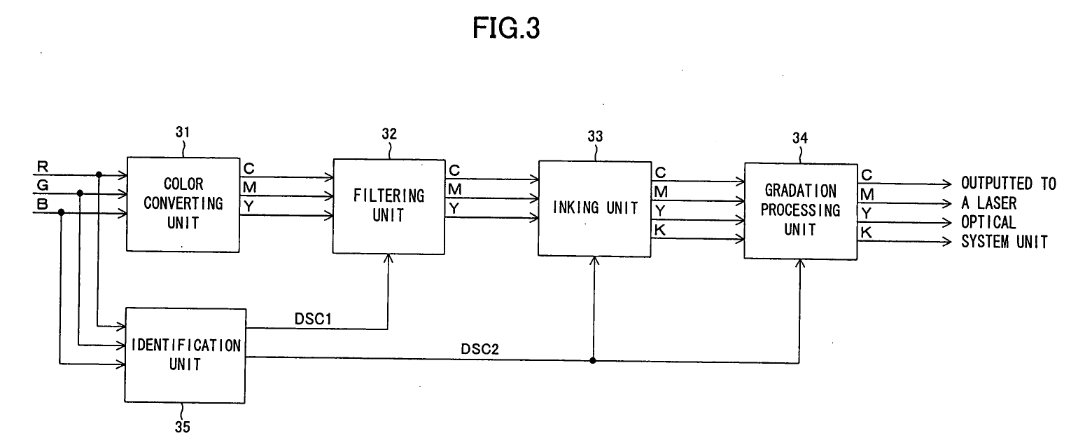

FIG. 3 shows a configuration of the image processing board 14. The image processing board 14 includes a color converting unit 31 for converting RGB signals into CMY signals, a filtering unit 32 for executing a filtering process to the signal after having been applied with the color conversion, an inking unit 33 for executing an inking process by the process of a UCR or the like on the signal after filtering, a gradation processing unit 34 for executing a gradation process such as tethering for the signal after having been applied with the inking process, and an identification unit 35 for identifying a character area and a photographic area of the supplied original document on pixel-to-pixel basis. On the basis of an original document mode received as an instruction via a control panel, not shown, various parameters are set by the CPU 201 for processing blocks thereof. The various parameters set in this manner are stored in the MEMORY 202.

The identification unit 35 generates an identification signal DSC1 and an identification signal DSC2 on the basis of the supplied RGB signal, and outputs the same to the filtering unit 32, the inking unit 33 and the gradation processing unit 34.

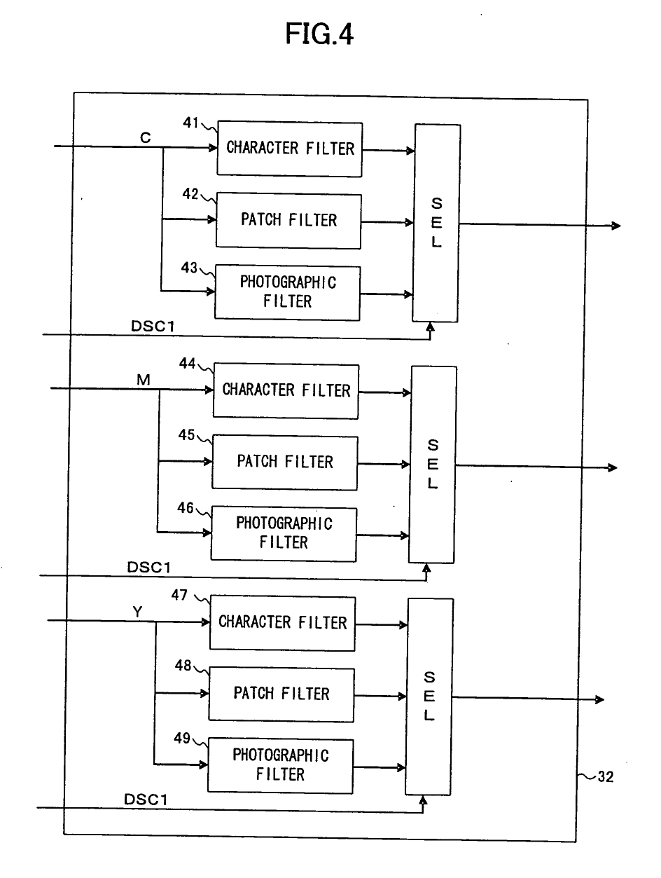

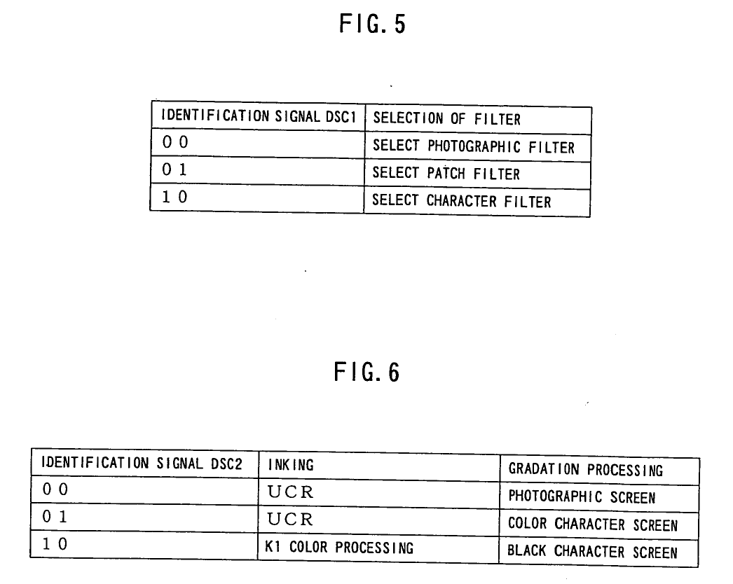

The filtering unit 32 includes three types of filters; character filters 41, 44, 47, patch filters 42, 45, 48 and photographic filters 43, 46, 49 for the CYM signals respectively as shown in FIG. 4. The identification signal DSC1 is a signal for selecting filtering results in the CMY colors respectively, and is a signal of 2bit×3ch (for C, M and Y). The relation between the value of the identification signal DSC1 and the filter selection is shown in FIG. 5.

The identification signal DSC2 supplied to the inking unit 33 and the gradation processing unit 34 and the contents of the operation of the respective processes are shown in FIG. 6. The identification signal DSC2 is a signal of 2 bits. As described above, the filtering process, the inking process, and the gradation process are switched by the identification signal.

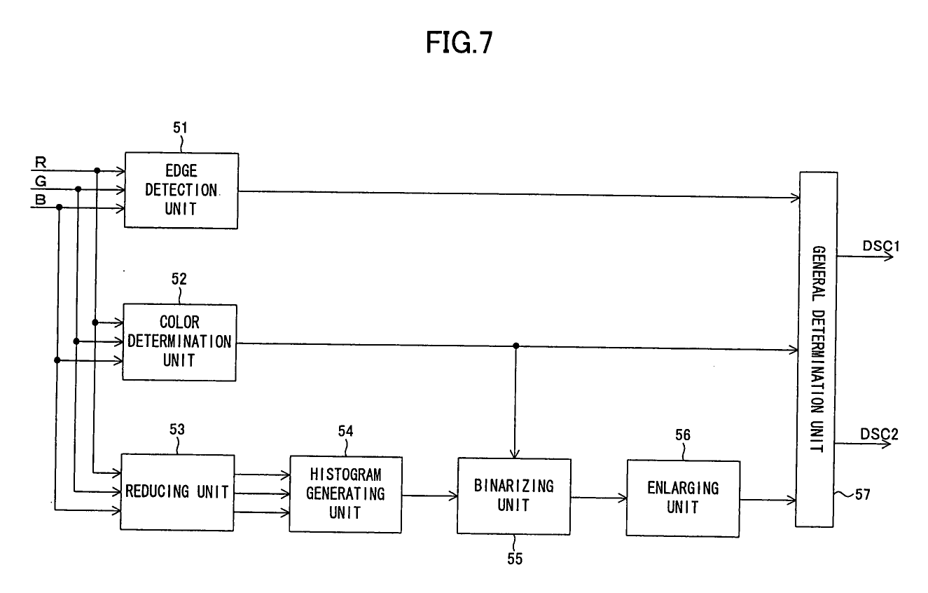

The configuration of the identification unit 35 is shown in FIG. 7. As shown in the same drawing, the identification unit 35 includes an edge detection unit 51, a color determination unit 52, a reducing unit 53, a histogram generating unit 54, a binarizing unit 55, an enlarging unit 56 and a general determination unit 57.

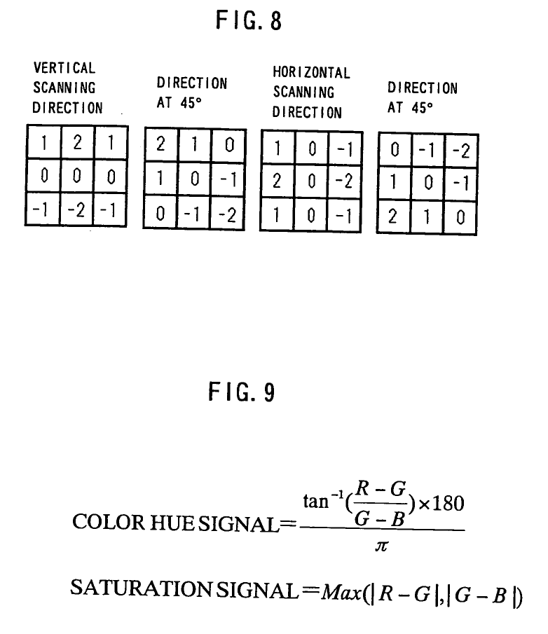

In the edge detection unit 51, an edge characteristic amount (edge strength, and the like) is calculated for the vertical, lateral, and oblique (two directions at 45°) for the RGB signals respectively using a matrix of 3×3 as shown in FIG. 8 (Sobel filter). For edge detection, the maximum value of the edge characteristic amounts in four directions is employed as an edge characteristic amount of a central pixel, and is compared with a predetermined threshold value. When the characteristic amount is larger than the predetermined threshold value, a value “1” is outputted, and if it is smaller than the threshold value, a value “0” is outputted.

The color determination unit 52 calculates color hue/saturation from the RGB signals. More specifically, the color hue signal/saturation signal is calculated from the RGB signals using an arithmetic expression shown in FIG. 9.

In this expression, MAX(|R−G|, |G−B|) is a calculation for comparing an absolute value of R−G and an absolute value of G−B and outputting the larger value. In this manner, the color hue is determined from the color hue/saturation signal. More specifically, the calculated saturation signal is compared with the threshold value thc and whether it is a chromatic color or Black (achromatic color) is determined.

When the saturation signal<thc, it is determined to be an achromatic color (Black), and when the saturation signal≧thc, it is determined to be a chromatic color.

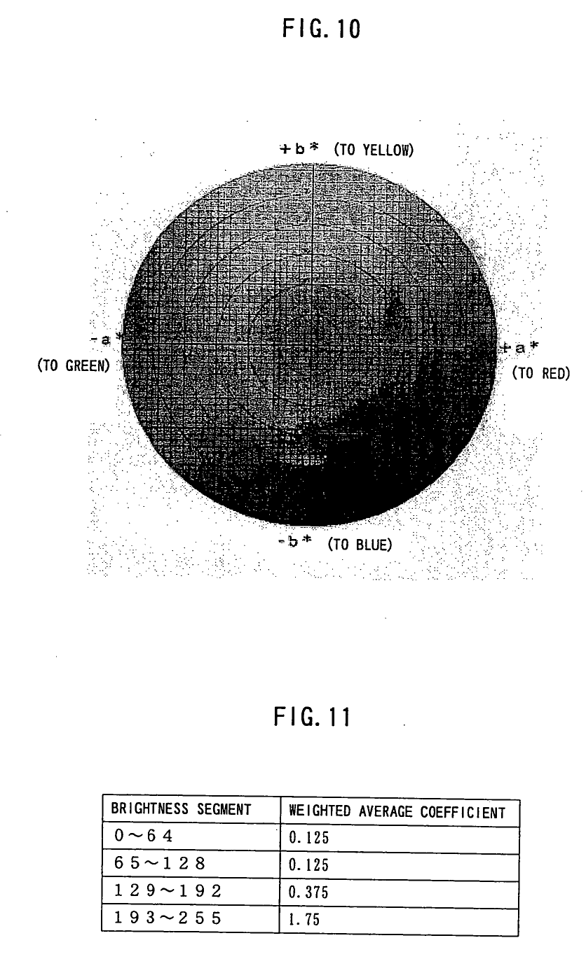

When it is determined to be an achromatic color in this determination, the value indicating that it is a Black color hue is outputted. Then when it is determined to be a chromatic color, the color hue is determined by using the color hue signal. More specifically, the color hue signal can indicate the color hue by the angles such as Yellow (about 90°), Green (180°), and Blue (270°) with reference to Red as 0° as shown in FIG. 10. Therefore, by comparing the obtained color hue signal with a conditional expression shown below, the color hue can be determined.

Conditional Expression;

Red, if the color hue signal≦thh1 or the color hue signal>thh6,

Yellow, if thh1<the color hue signal≦thh2,

Green, if thh2<the color hue signal≦thh3,

Cyan, if thh3<the color hue signal≦thh4,

Blue, if thh4<the color hue signal≦thh5, and

Magenta, if thh5<the color hue signal≦thh6.

With the process described above, the value “0” is outputted when it is Black, the value “1” is outputted when it is Red, the value “2” is outputted when it is Yellow, the value “3” is outputted when it is Green, the value “4” is outputted when it is Cyan, the value “5” is outputted when it is Blue, and the value “6” is outputted when it is Magenta.

In the reducing unit 53, the input signal is reduced to ¼ in vertical scanning and horizontal scanning (resolution of the image in the image data to be processed is reduced). The reduction process is the one using a weighted average. More specifically, a coefficient of the weighted average is defined from the signal values of the RGB colors using a table shown in FIG. 11.

The reducing unit 53 calculates the weighted average for every pixel area of four rows by four columns and generates a reduced image. When all the weighted average coefficients are set to 1.0, it becomes the same value as a simple averaging.

The histogram generating unit 54 generates a histogram of a color space signal in a pixel area of M rows by N columns (here, M, N are 1 or larger integers) in the image which is reduced in the reducing unit 53. Here, a case of M=N=7 is shown for example. The histogram is generated by dividing the RGB signal values 0-255 by 32. The histogram is generated for every pixel in sequence and binarizing process is applied by the binarizing unit 55.

The binarizing unit 55 executes the binarizing process on a target pixel (pixel in the image which is reduced by the reducing unit) by the binarizing threshold which is predetermined on the basis of the histogram generated by the histogram generating unit 54 and a color hue of a target pixel (a center pixel of a 7×7 reference area).

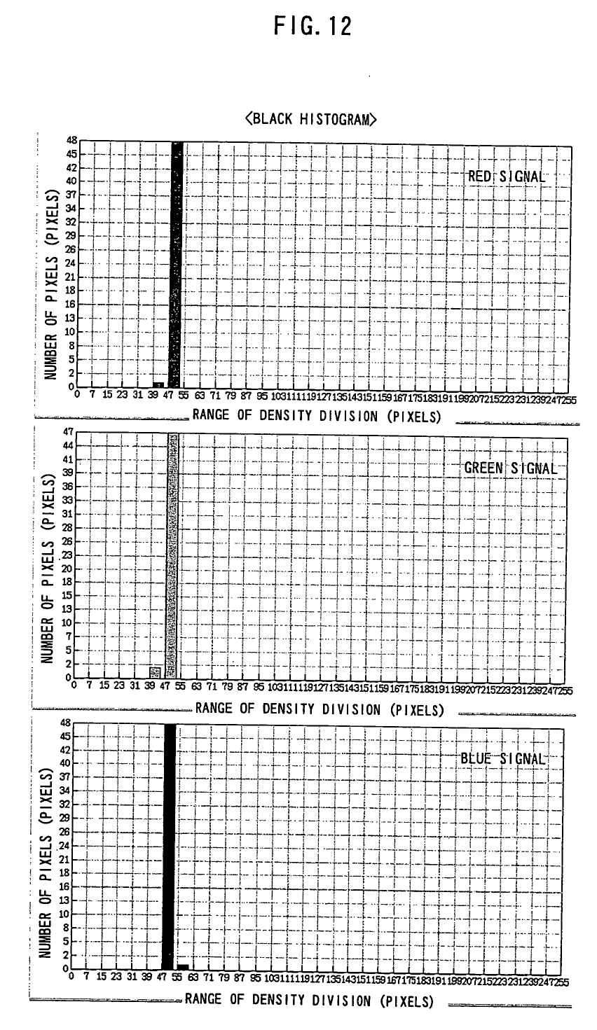

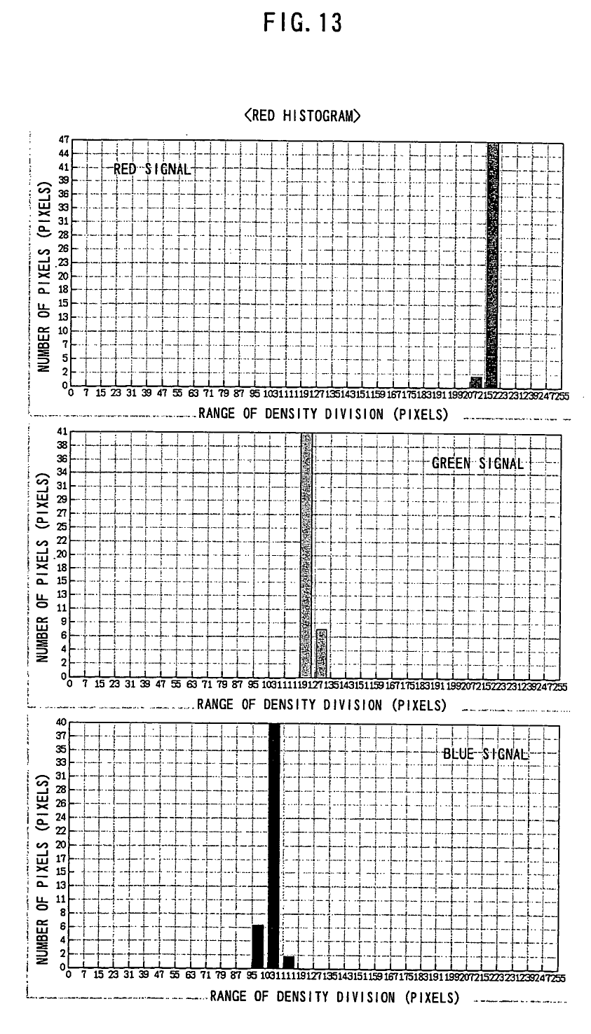

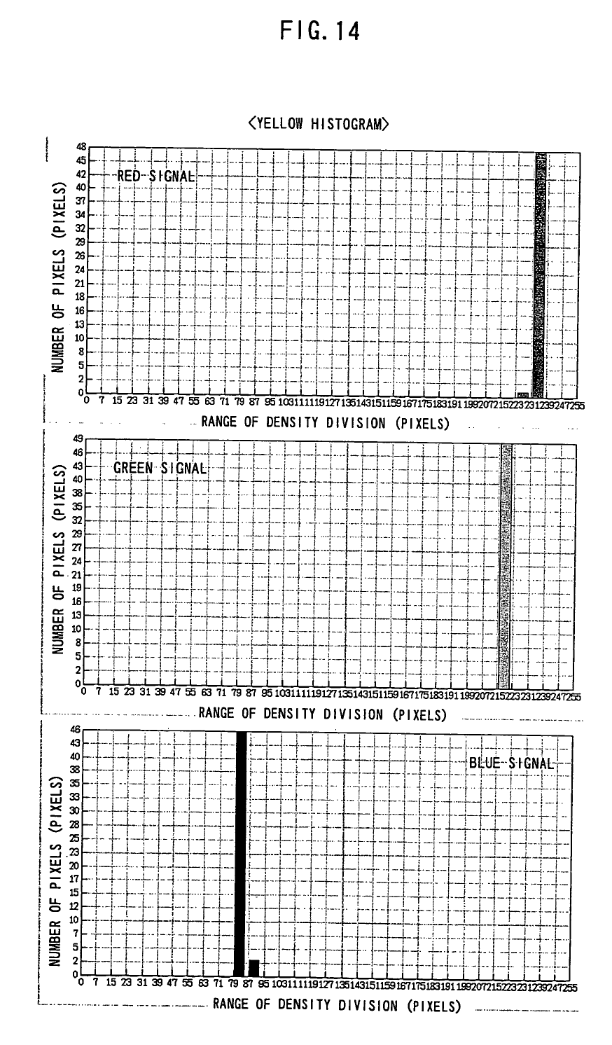

As shown in FIG. 12 to FIG. 14, the forms of the histogram of the RGB signals are different depending on the color in the original document. When it is black, all the three colors of RGB are varied according to the density of the black (see FIG. 12), while the signals which vary according to the density are Green and Blue signals (see FIG. 13) in the case of red, and the signal which varies according to the density is Blue in the case of yellow (see FIG. 14). In the binarizing unit 55, the binarizing process is executed for the RGB signals that vary according to the density of the color. Therefore, since it is necessary to switch the binarizing threshold value according to the color of the original document, the binarizing threshold value is selected using the color hue of the target pixel.

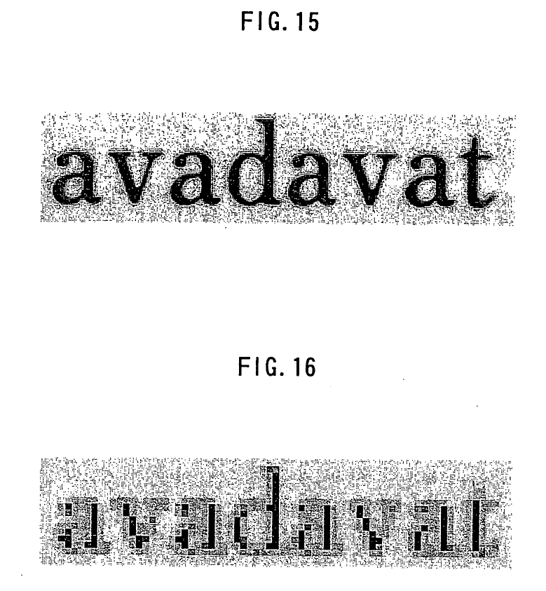

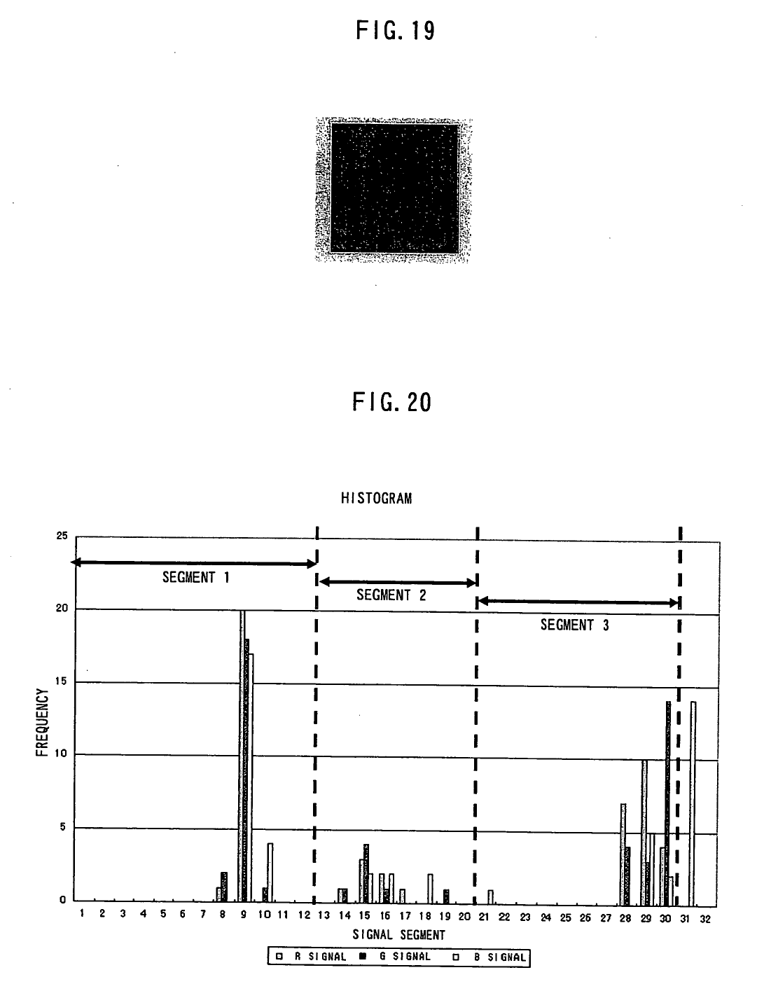

Subsequently, referring to FIG. 15 to FIG. 20, the binarizing process on a character image and a patch image of a uniform density will be described.

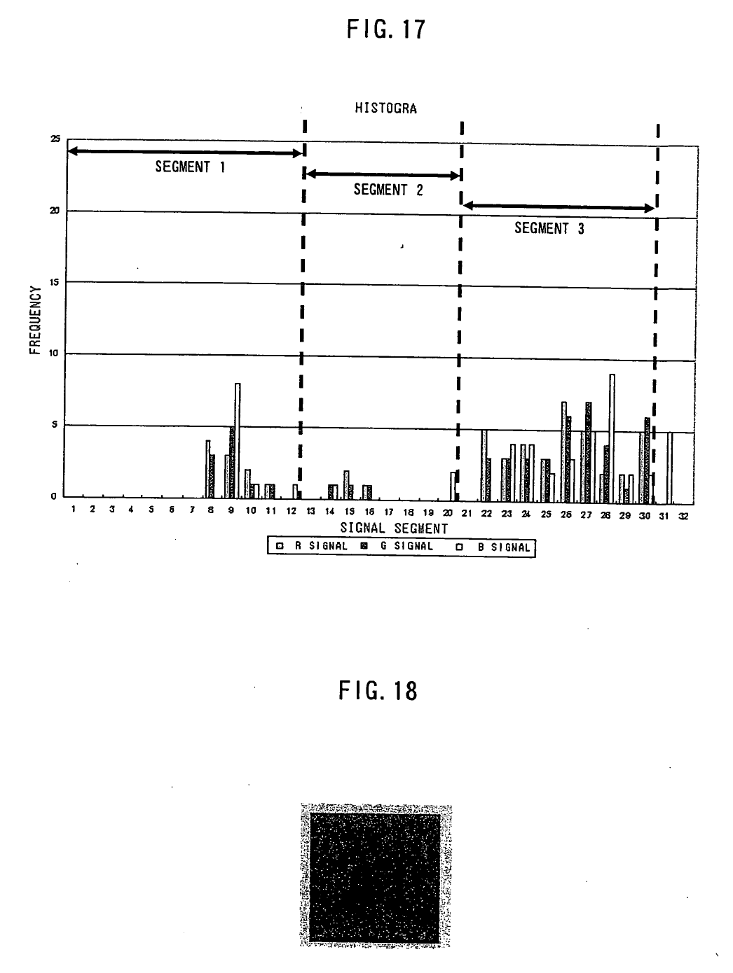

FIG. 15 to FIG. 17 show examples of black characters. FIG. 15 is an image in 600 dpi. The reduced image thereof after applying the weighted average is an image shown in FIG. 16. A histogram generated for an initial character “a” in this reduced image in an area of 7 pixels×7 pixels is shown in FIG. 17. In the binarizing process, the histogram is divided into three signal segments (density segments), and the total number of color contents in the respective segments (usage frequency) is firstly calculated. For example, it is assumed that a segment 1 is 1-12, a segment 2 is 13-20, and a segment 3 is 21-30. The total number in the R signal in the segment 1 is 10, the total number in the segment 2 is 3, and the total number in the segment 3 is 36.

Subsequently, the total number in the segment 1 is compared with the threshold value th1, and if the total number in the segment is equal to or larger than the threshold value, the target pixel is binarized using the binarizing threshold value 1. If the total number in the segment 1 is smaller than the threshold value th1, the total numbers in segment 2 and the segment 3 are compared. Then, if the total number in the segment 2 is equal to or larger than the total number in the segment 3, the target pixel is binarized using a binarizing threshold value 2. When the total number is equal to or smaller than the binarizing threshold value, the value “1” is outputted, and if not, the value “0” is outputted. In the case in which the total number in the segment 3 is larger than the total number in the segment 2, the target pixel is outputted as a value “0”. Therefore, in a case in which the threshold value th1 is 15, the binarizing threshold value 1 is 180 and the binarizing threshold value 2 is 152, the target pixel is outputted as a value “0” in the case of the image shown in FIG. 15.

The same process is executed also for the G signal and B signal, and “or” of the binarized result is obtained for the respective RGB signals, whereby the final binarized image is generated.

In FIG. 18 to FIG. 20, a case in which the patch image of a uniform density is exemplified. In the case of the patch of a uniform density (the boundary portion with respect to the background) as shown in FIG. 18, the total numbers are 21 in the segment 1, 7 in the segment 2, and 21 in the segment 3. When the same process as described above is executed, the binarizing process is executed with the binarizing threshold value 1, and the area of a uniform density is outputted as “1”.

In the process shown above, the area of a uniform density in the original document can be extracted. Although the black color is exemplified in the description in conjunction with FIG. 15 to FIG. 20, the areas of a uniform density in the respective colors can be extracted by setting the ranges of the segments 1-3, and the binarizing threshold values 1 and 2 for the respective colors in the original document adequately. In this manner, the binarizing unit 55 divides the histogram generated by the histogram generating unit 54 into at least two density segments, selects at least one predetermined threshold value on the basis of the usage frequency of the color contents in the respective segments, and executes binarizing process on the pixels in the image which is reduced by the reducing unit.

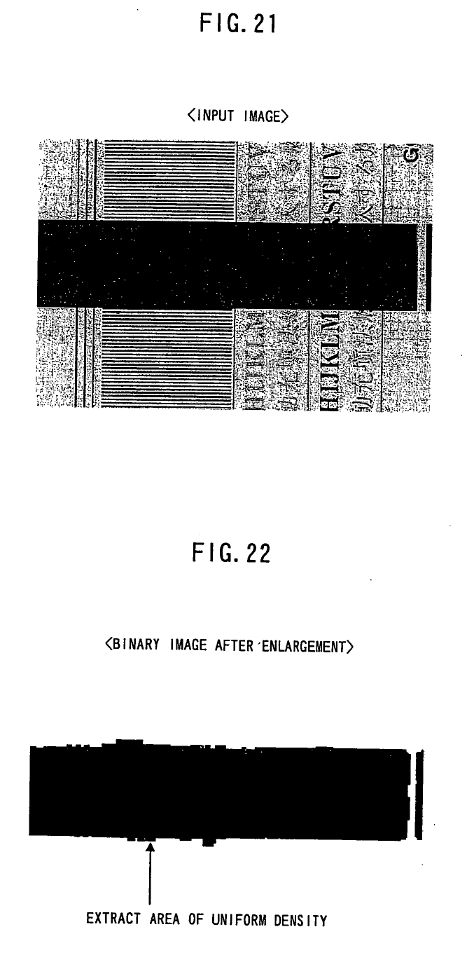

The enlarging unit 56 executes an enlarging process of four times by simply performing padding on the binarized image. With this process, the binarized image outputted after enlarging process is a signal that is a result of detection of the area of a uniform density. An example of the input image is shown in FIG. 21 and a binarized image obtained by executing the enlarging process on the input image in FIG. 21 is shown in FIG. 22.

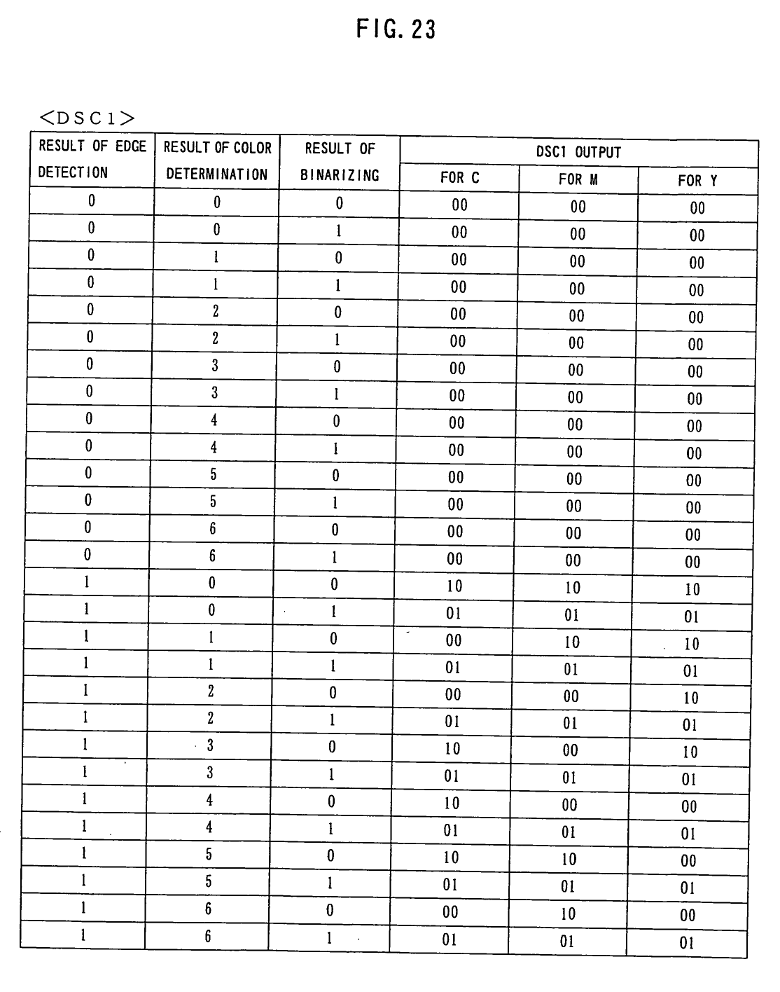

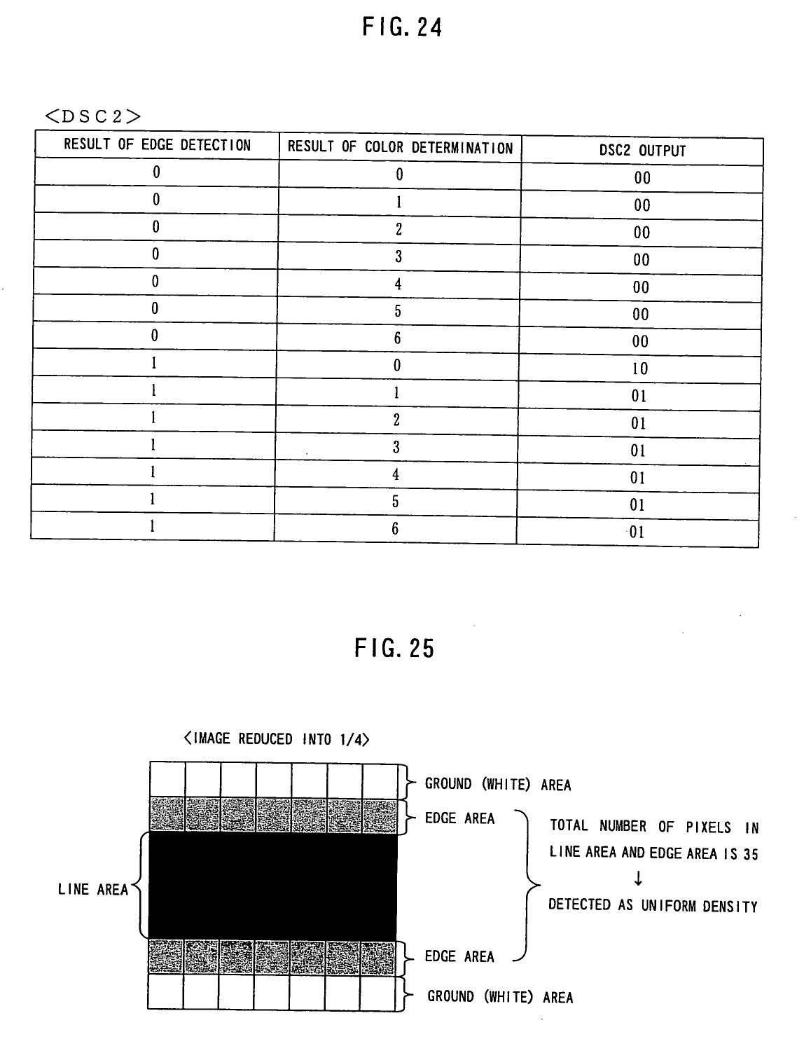

In the general determination unit (area discrimination unit, image type discrimination unit) 57, the DSC1 and DSC2 signals are generated on the basis of the result of edge detection, the result of color determination, and the result of binarizing process according to FIG. 23 and FIG. 24. The general determination unit 57 determines the pixel area of a uniform density having a thickness of at least a predetermined value in the image in the image data on the basis of the image binarized in the binarizing unit 55. The general determination unit 57 determines which one of the character, the patch image of a uniform density and the non-edge image the pixel area of a uniform density having a thickness of at least the predetermined value in the image in the image data constitutes on the basis of the discriminated pixel area of a uniform density and the result detected by the edge detection unit 51.

In this manner, by combining the result of edge detection, the result of color determination, and the result of the binarizing process, discrimination among the photograph, the uniform patch and the character is achieved with the DSC1, and discrimination among the photograph, the colored character and the black character is achieved with the DSC2.

The detected line width of a uniform density can be controlled by changing the reduction ratio and the histogram reference area in the binarizing process. The reduction of ¼ and the histogram area of 7×7 are exemplified in the configuration shown above, and in this case, the line width of at least 0.5 mm can be detected (in the case of 600 dpi). Referring now to FIG. 25, the relation of the reduction ratio and the histogram reference area with respect to the detectable line width will be described. When the histogram reference range is 7×7, if there exists a line width of at least three pixels in the reference range, the frequency of existence on the high-density side of the histogram (0 side since it is the RGB signal) is 21, and it will be 35 when the edge area is added, so that the frequency of at least a half the total number is distributed on the high-density side. Since the high-density side is the segment 1 or the segment 2, it is detected as a uniform density in the binarizing process.

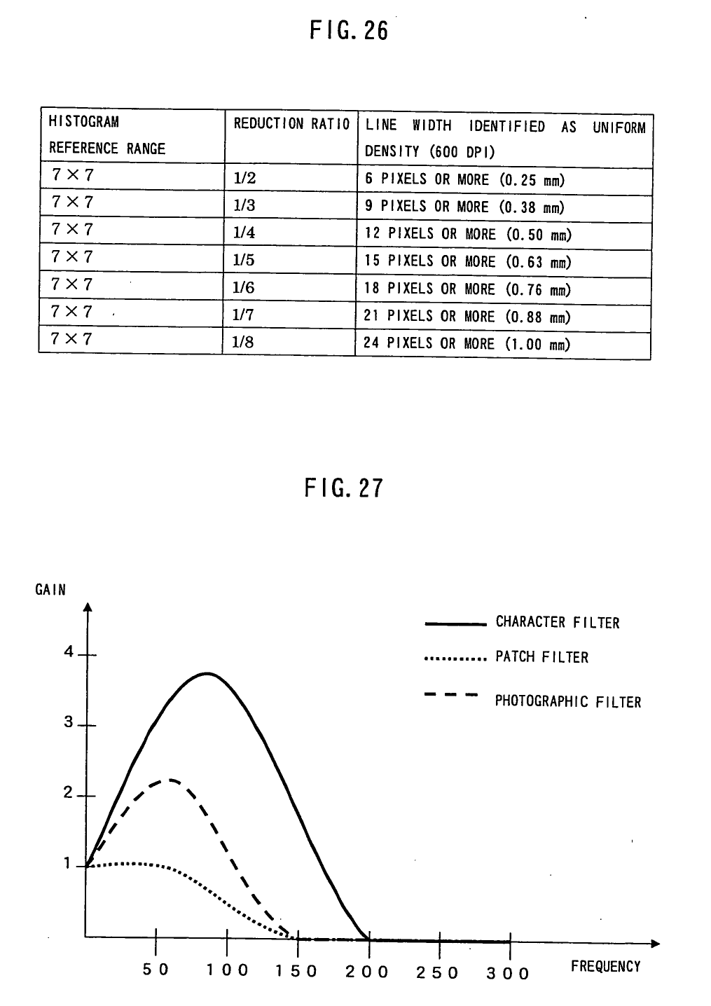

Therefore, if the line width of at least three pixels exists in the reduced image, it can be detected as a uniform density. In the case in which the reduction ratio is ¼ and the reference range is 7×7, the line width identified to be the uniform density will be; 3 pixels×4=12 pixels, and when it is converted by 600 dpi, it will be 12×0.0423=0.5 mm. The line widths that can be detected according to the reduction ratio are shown in FIG. 26.

Subsequently, in the case in which the reduction ratio is ¼ and the histogram reference area is 15×15, the number of lines which is required for achieving at least a half of the frequency is 8 lines. Therefore, from 8×4=24 pixels, the line width of at least 1.00 mm can be detected.

When the relation as described above is expressed in a numerical expression, where N represents the total number of histogram frequency and Mag represents the reduction ratio (0.5 if it is the reduction of ½), the following expression is established.
Line Width (mm)=((N/2)/Mag)×0.0423

In this manner, by changing the reference range when generating the reduction ratio or the histogram in the reducing process, the detectable width (thickness) of the patch image area of a uniform density, that is, the detectable line width or the like can be controlled.

In the filtering unit (filter selecting unit) 32, switching among the photographic filter, the patch filter, and the character filter is executed according to the DSC1 signal outputted from the identification unit 35. In this manner, the filtering unit 32 selects the type of the filtering applied to the pixel area of each image type on the basis of the image type discriminated by the general determination unit 57. Frequency characteristics of the respective filters are shown in FIG. 27.

The photographic filter is designed to emphasize the component of about 75 lines in order to emphasize the character or the like written by hand with a pencil, and remove the frequency component of 150 lines or larger, which is a general number of lines in half-tone image. The patch filter is designed to smoothen by LPF. The character filter is designed so as to emphasize the frequency of about 100 lines in order to emphasize the printed character.

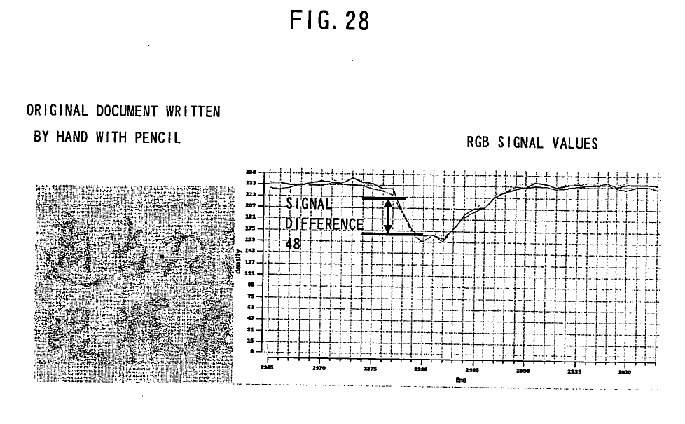

The reason why the photographic filter is selected in the character written by hand with the pencil is because the character written with the pencil is low in density and the signal difference between a peripheral white base and the character written with the pencil is about 48 in terms of RGB signals as shown in FIG. 28. Since it is not detected as the edge with such a small signal difference in the edge detecting process, the photographic filter is selected. In this manner, by switching the filtering process using the DSC1 signal, a process of emphasizing the character written with the pencil and constraining a noise of the patch of a uniform density is enabled.

### Second Embodiment

Subsequently, a second embodiment of the present invention will be described. In the present embodiment, the image (patch image) area of a uniform density having a thickness of at least a predetermined value can be extracted by using the binarizing process as in the case of the first embodiment.

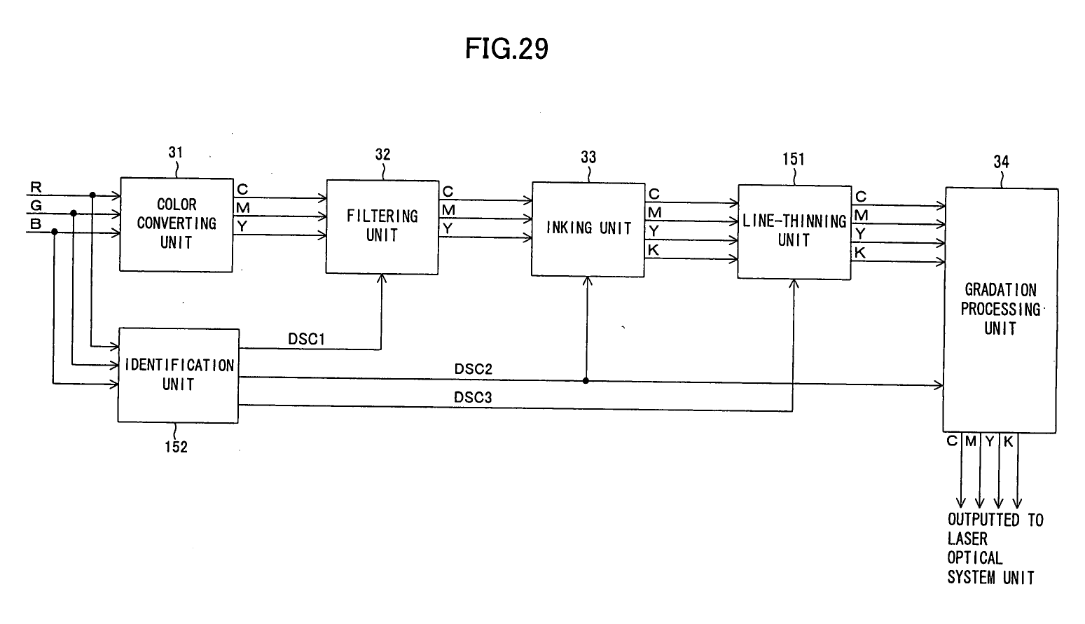

In the present embodiment, edge pixels of the pixel area (the pixels that constitute the outline portion) of a uniform density having a thickness of at least the predetermined value are detected by combining the binarizing process and the edge detecting process. The line-thinning process can be applied on the character by using the detected result. FIG. 29 shows a configuration of the image processing board on which a line-thinning unit 151 is added to the configuration in the first embodiment. The same parts as those in the first embodiment are represented by the same reference numerals and description thereof will be omitted.

As shown in FIG. 29, the image processing board in this embodiment, the line-thinning unit 151 is arranged on the downstream of the inking process 33. The CMYK signals and a DSC3 outputted from an identification unit 152 are supplied to the line-thinning unit 151. The line-thinning unit 151 executes the line-thinning process when it is the edge of a line width equal to or larger than the certain value using the entered DSC3 signal, and does not execute the line-thinning process when it is the edge pixel of the image area smaller than the certain thickness (or the line width). In this manner, by executing the line-thinning process specifically on the image area such as the line having a thickness (width) of at least a certain value, discontinuation of the line at a thinned portion in a character that varies in thickness from a thick line to a thin line such as Mincho-style can be avoided.

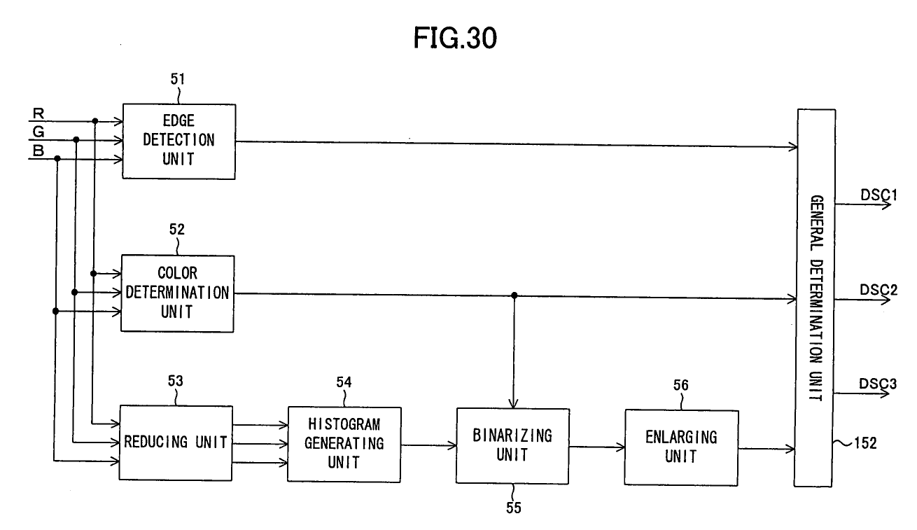

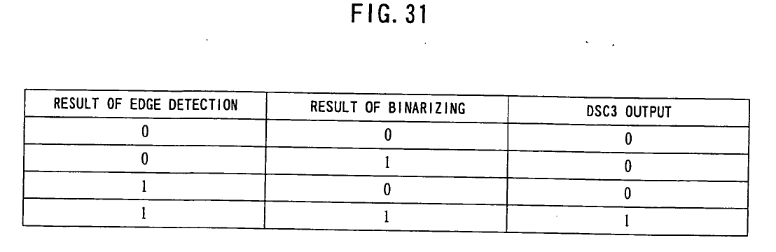

A block diagram of the identification unit 152 in the present embodiment is shown in FIG. 30. As shown in FIG. 30, a different point of the identification unit according to the present embodiment from the identification unit according to the first embodiment is the function of the general determination unit. The DSC1 signal and the DSC2 signal outputted from the general determination unit 152 are the same as those in the first embodiment. The DSC3 signal is generated using the result of the edge detection and the result of the binarizing process according to a table shown in FIG. 31.

As shown in the table in FIG. 31, the DSC3 output is the signal of 1 bit, “0” represents the line-thinning process OFF, and “1” represents the line-thinning process ON.

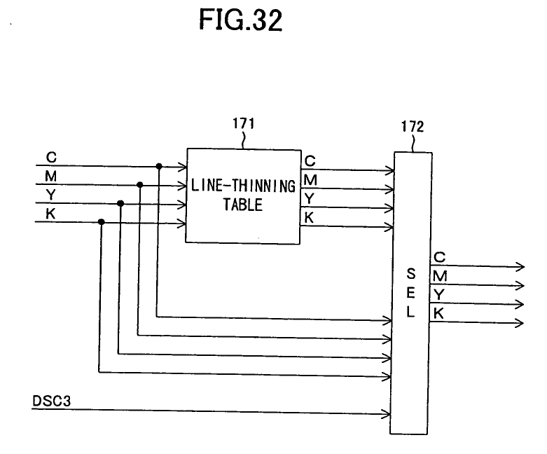

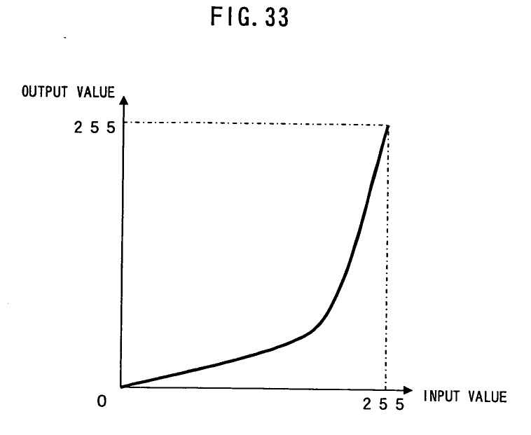

The configuration of the line-thinning process 151 is shown in FIG. 32. The CMYK signal entered into the line-thinning unit 151 is entered into a line-thinning table 171 and an SEL 172. The signal conversion is executed in the line-thinning table 171 using a table shown in FIG. 33. In the SEL 172, one of the signal outputted from the line-thinning table 171 and the CYMK input signal is selected on the basis of the DSC3 signal. The SEL 172 outputs the CMYK input signal when the DSC3 signal is “0”, and the line-thinning table 171 output signal is selected when the DSC3 signal is “1”.

When the DSC3 signal is “1”, since it means that it is an edge pixel of the pixel area having a line width of at least a certain value, an edge signal value is converted into a value lower than the input value by the line-thinning table 171. In other words, since the density of the edge is lowered, the line-thinning is achieved. The line-thinning table used here may be held as an independent table for the respective CMYK signals or may be held as a common table for the CMYK signals.

In this manner, the line-thinning unit 151 executes the line-thinning process for the pixels detected by the edge detection unit 51 as the pixels that form the outline of the pixel area of a uniform density out of the pixels that are discriminated by the general determination unit 152 to be those that constitute the pixel area of a uniform density having a thickness of at least the predetermined value in the image in the image data.

### Third Embodiment

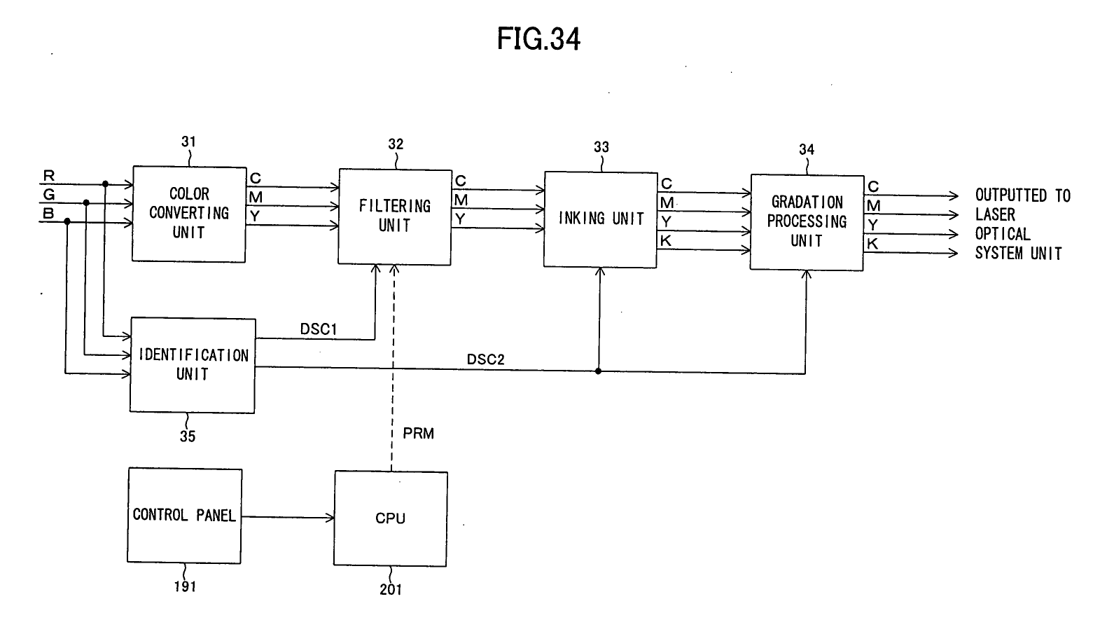

Subsequently, a third embodiment of the present invention will be described. FIG. 34 shows a configuration of the image processing board in the present embodiment. The same parts as those in the above described embodiments are represented by the same reference numerals and description thereof will be omitted.

As shown in FIG. 34, a document mode or a sharpness adjustment value set by a user is inputted from a control panel 191 into the CPU 201.

In the CPU (Parameter setting unit) 201, the parameter setting is executed for each image processing according to the preset value such as the document mode. In FIG. 34, since only the parameters to be set for the filtering process 32 are changed regarding the sharpness adjustment, a line indicating a flow of the signal when setting the parameters for other processes from the CPU 201 is omitted.

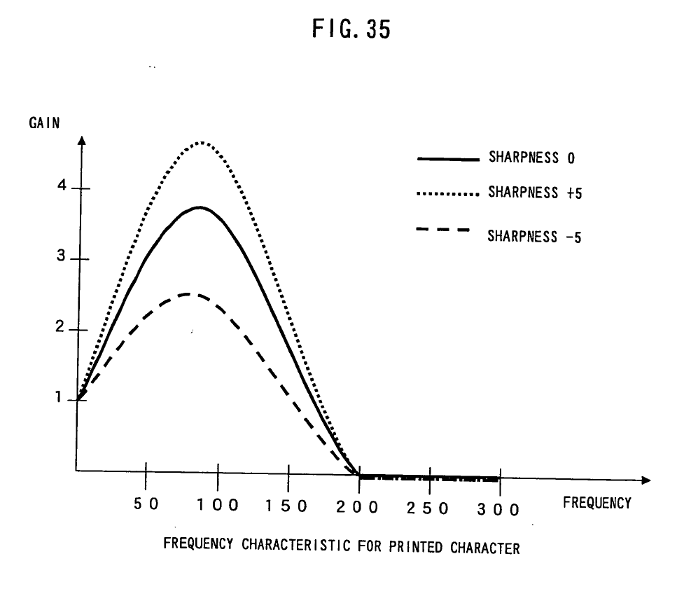

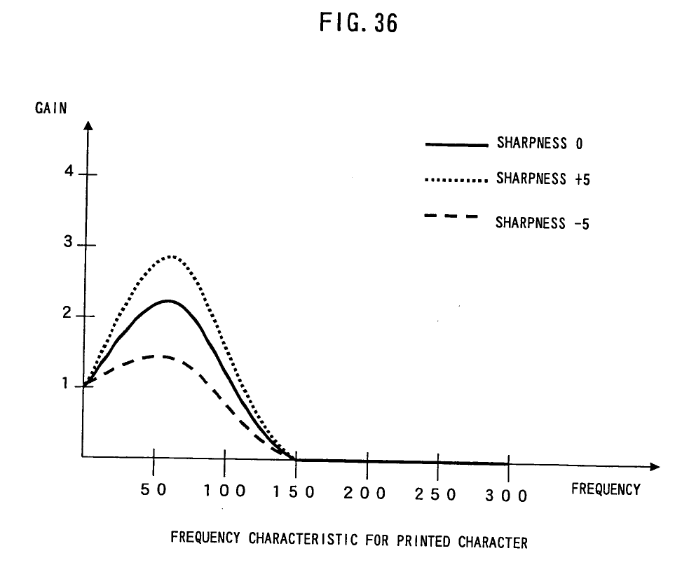

The control panel 191 includes adjustment screens such as a sharpness adjustment for printed characters (−5(low) to +5(high)) and a sharpness adjustment for characters written with the pencil (−5(low) to +5(high)). When the user sets the respective adjustment values, the values from −5 to +5 for each sharpness adjustment are outputted to the CPU 201. In the CPU 201, a filter coefficient PRM having frequency characteristics shown in FIG. 35 and FIG. 36 is calculated on the basis of the sharpness adjustment values. The calculated filter coefficient PRM is entered into the filtering unit 32, so that a coefficient for the character written with the pencil is set for the photographic filter, and a coefficient for the printed character is set for the character filter. Adjustment is not executed for the patch filter, and the characteristic of the LPF is employed.

As shown in the first embodiment, the photographic filter is selected for the character written with the pencil. Therefore, by setting the filter coefficient reflecting the sharpness adjustment value to the photographic filter, the characters written with the pencil can be emphasized. In addition, since it is separated from the patch image filter, adjustment is achieved without generating a noise due to excessive emphasis of the patch image of a uniform density. It is the same also for the printed character, and the filter adjustment can be achieved without excessively emphasizing the outline of the patch image of a uniform density.

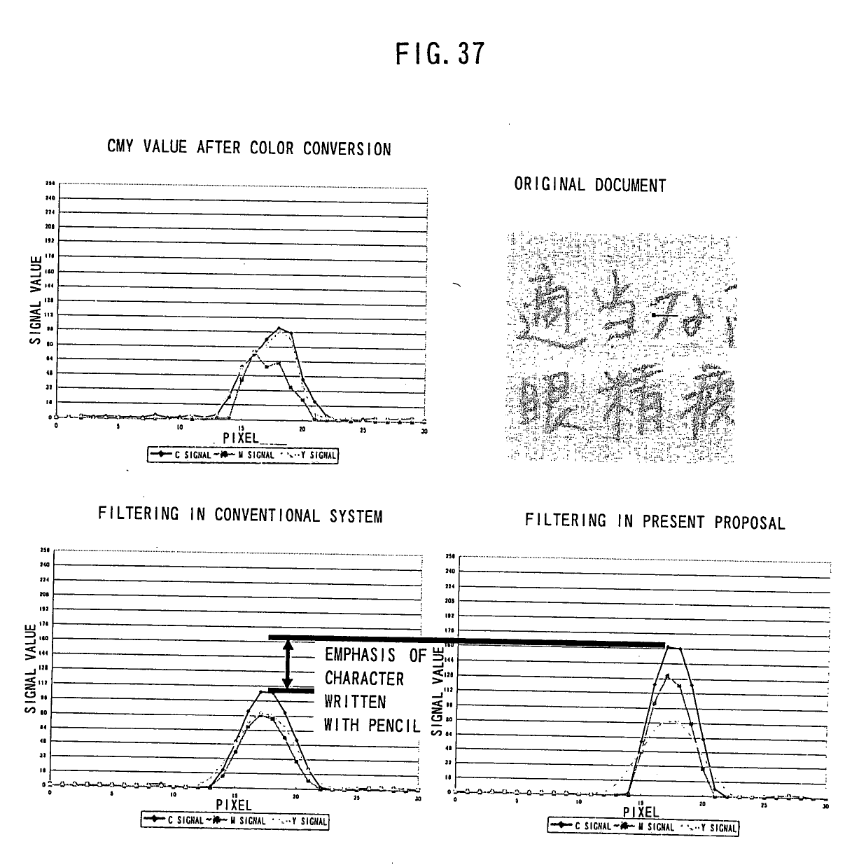

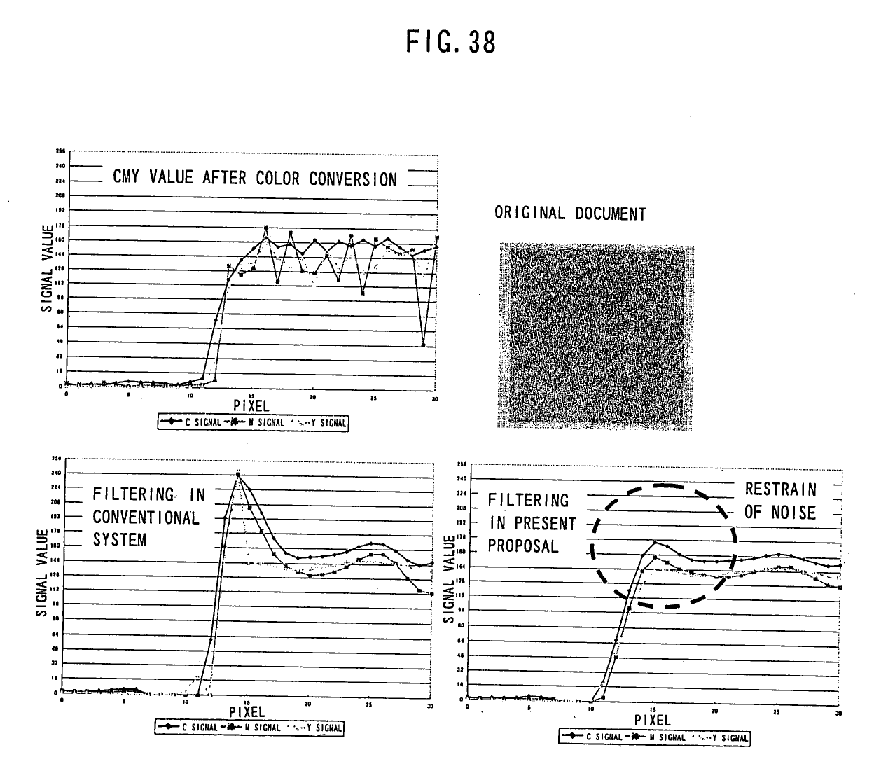

In addition, it is also possible to automatically set the parameters for filtering process to be applied to the pixel areas for the respective image types on the basis of the image types discriminated by the general determination unit (image type discrimination unit) in the CPU 201. The effects of the respective embodiments described above are shown in FIG. 37 and FIG. 38. FIG. 37 is a drawing showing the fact that an adequate emphasizing process is applied when the input image is the character written with the pencil, and FIG. 38 is a drawing showing the fact that an adequate filtering process is achieved without generating the noise that may be caused by excessively emphasizing the edge portion of the patch image in the case in which the input image is the patch image of a uniform density.

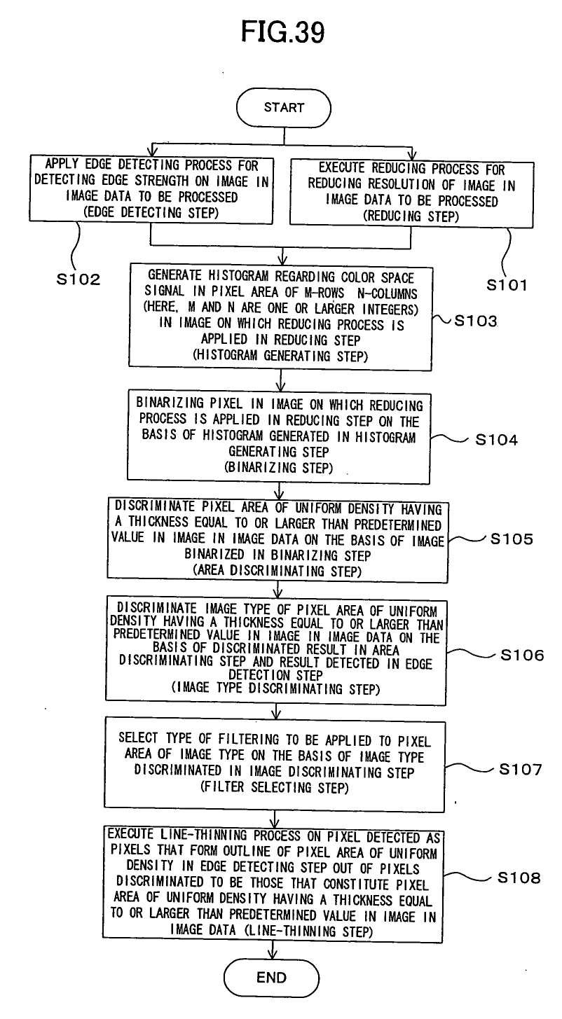

FIG. 39 is a flowchart for explaining a flow of a process in the image processing apparatus (image processing method) according to the present embodiment.

The reducing unit executes a reducing process for reducing the resolution of the image in the image data to be processed (reducing step) (S101).

The edge detection unit executes an edge detecting process for detecting the edge strength for the image in the image data to be processed in parallel with the above-described reducing step (edge detecting step) (S102). Although an example in which the reducing step and the edge detecting step are performed in parallel is shown here, the invention is not limited thereto, and may be of a configuration in which any one of these steps is executed in advance.

The histogram generating unit generates a histogram relating to the color space signal in the pixel area of M rows×N columns (here, M, N are 1 or larger integers) in the image to which the reducing process is applied in the reducing step (histogram generating step) (S103).

The binarizing unit executes the binarizing process on the pixels in the image to which the reducing process is applied in the reducing step on the basis of the histogram generated by the histogram generating step (binarizing step) (S104). More specifically, in the binarizing step, the histogram generated in the histogram generating step is divided into at least two density segments, selects at least a predetermined threshold value on the basis of the frequency of usage of the color components in the respective segments, and executes binarizing process on the pixels in the image to which the reducing process is applied in the reducing step.

Then, the general determination unit determines the pixel area of a uniform density having a thickness equal to or larger than the predetermined value in the image in the image data on the basis of the image binarized in the binarizing step (area discriminating step) (S105).

The general determination unit determines the image type of the pixel area of a uniform density having a thickness equal to or larger than the predetermined value in the image in the image data on the basis of the result discriminated in the area discriminating step and the result detected in the edge detecting step (an image type discriminating step) (S106).

The filter processing unit selects the type of the filter processing to be applied to the pixel area for the respective image types on the basis of the image type discriminated in the image type discriminating step (a filter selecting step) (S107).

The line-thinning unit executes the line-thinning process on the pixels detected as those that form the outline of the pixel area of a uniform density in the edge detecting step out of the pixels discriminated in the area discriminating step to be those that constitute the pixel area of a uniform density having a thickness equal to or larger than the predetermined value in the image in the image data (a line-thinning step) (S108).

The respective steps in the process in the above-described image processing apparatus are achieved by causing the CPU 201 to execute the image processing program stored in the MEMORY 202.

In the present embodiment, the case in which the function for executing the invention is stored in advance in the apparatus has been described. However, the invention is not limited thereto, and corresponding function can be downloaded from a network to the apparatus or the same function stored in the storage medium may be installed in the apparatus. The recording medium may be of any form as long as it can store the program and the apparatus can read it, such as a CD-ROM or the like. The function obtained by installing or downloading in advance as described above may be the one that achieves the function in cooperation with an Operating System or the like in the apparatus.

As described above, by combining the binarizing process using the reducing process and the histogram and the edge detecting process, the patch area of a uniform density and the edge thereof can be detected. By controlling the filtering process on the basis of the detected result, both of the reproduction of the character written with the pencil and the reduction of noise in the uniform patch, which were not achieved together in the related art, can be achieved. In addition, the emphasizing of the printed character and the noise reduction of the outline of the patch of a uniform density can be achieved.

In addition, since the edge of a width equal to or larger than the certain value can also be detected, the amount of toner consumption can be reduced and discontinuation in the character can be avoided, thereby realizing a favorable image quality by combining with the line-thinning process.

Although the present invention has been described in detail on the basis of a specific form, it will be understood by those skilled in the art that various modification and change in quality may be made without departing the spirit and the scope of the present invention.

As described thus far, according to the present invention, a technology that can contribute to realization of both of the reproduction of a fine line in low density and the reduction of noise in an outline portion of a patch area of a uniform density, which were not achieved together in the related art, can be provided.

What is claimed is:

1. An image processing apparatus comprising:
a reducing unit that executes a reducing process for reducing the resolution of an image in image data to be processed;
a histogram generating unit that generates a histogram of a color space signal in a pixel area of M rows×N columns (here M, N are one or larger integers) in the image on which the reducing process is applied by the reducing unit; and
a binarizing unit that executes a binarizing process on a pixel in the image on which the reducing process is applied by the reducing unit on the basis of the histogram generated by the histogram generating unit.

2. The image processing apparatus according to claim 1, comprising an area discrimination unit for discriminating a pixel area of a uniform density having a thickness equal to or larger than a predetermined value in the image in the image data on the basis of the image binarized by the binarizing unit.

3. The image processing apparatus according to claim 1, wherein the binarizing unit divides the histogram generated by the histogram generating unit into at least two density segments, selects at least one of predetermined threshold values on the basis of a frequency of usage of color contents in the respective segments, and executes the binarizing process for the pixel in the image on which the reducing process is applied by the reducing unit.

4. The image processing apparatus according to claim 2 comprising:
an edge detection unit that executes an edge detecting process for detecting edge strength on the image in the image data as the target of processing; and
an image type discrimination unit that discriminates an image type of the pixel area of the uniform density having a thickness equal to or larger than the predetermined value in the image in the image data on the basis of a result of discrimination by the area discrimination unit and a result detected by the edge detection unit.

5. The image processing apparatus according to claim 4, wherein the image type discrimination unit discriminates which one of the character, the patch image of a uniform density and the non-edge image the pixel area of a uniform density having a thickness equal to or larger than the predetermined value in the image in the image data constitutes on the basis of the result of the discrimination by the area discrimination unit and the result detected by the edge detection unit.

6. The image processing apparatus according to claim 4, comprising a filter selecting unit for selecting a type of filtering process to be applied to the pixel area for the respective image types on the basis of the image type discriminated by the image type discrimination unit.

7. The image processing apparatus according to claim 6, comprising a parameter setting unit for setting parameters of the filtering process to be applied to the pixel areas for the respective image types on the basis of the image type discriminated by the image type discrimination unit.

8. The image processing apparatus according to claim 2 comprising:
an edge detection unit that applies an edge detecting process for detecting edge strength on the image in the image data as the target of processing; and
a line-thinning unit that executes a line-thinning process on the pixels detected as those that form an outline of the pixel area of a uniform density by the edge detection unit out of the pixels discriminated by the area discriminating unit to constitute the pixel area of a uniform density having a thickness equal to or larger than the predetermined value in the image in the image data.

9. An image processing method comprising:
a reducing step that executes a reducing process for reducing the resolution of an image in image data to be processed;
a histogram generating step that generates a histogram of a color space signal in a pixel area of M rows×N columns (here M, N are one or larger integers) in the image on which the reducing process is applied in the reducing step; and
a binarizing step that executes a binarizing process on a pixel in the image on which the reducing process is applied in the reducing step on the basis of the histogram generated in the histogram generating step.

10. The image processing method according to claim 9, comprising an area discriminating step for discriminating a pixel area of a uniform density having a thickness equal to or larger than a predetermined value in the image in the image data on the basis of the image binarized in the binarizing step.

11. The image processing method according to claim 9, wherein the binarizing step divides the histogram generated in the histogram generating step into at least two density segments, selects at least one of the predetermined threshold value on the basis of a frequency of usage of color contents in the respective segments, and executes the binarizing process for the pixel in the image on which the reducing process is applied in the reducing step.

12. The image processing method according to claim 10 comprising:
an edge detecting step that executes an edge detecting process for detecting edge strength on the image in the image data as the target of processing; and
an image type discriminating step that discriminates the image type of the pixel area of a uniform density having a thickness equal to or larger than the predetermined value in the image in the image data on the basis of a result of discrimination in the area discriminating step and a result detected in the edge detecting step.

13. The image processing method according to claim 12, comprising a filter selecting step for selecting a type of filtering process to be applied to the pixel area for the respective image types on the basis of the image type discriminated in the image type discriminating step.

14. The image processing method according to claim 10 comprising:
an edge detecting step that applies an edge detecting process for detecting edge strength on the image in the image data as the target of processing; and
a line-thinning step that executes a line-thinning process for the pixels detected as pixels that form an outline of the pixel area of a uniform density in the edge detecting step out of the pixels discriminated in the area discriminating step to be those that constitute the pixel area of a uniform density having a thickness equal to or larger than the predetermined value in the image in the image data.

15. An image processing program that causes a computer to execute a reducing step that executes a reducing process for reducing the resolution of an image in image data to be processed;
a histogram generating step that generates a histogram of a color space signal in a pixel area of M rows×N columns (here M, N are one or larger integers) in the image on which the reducing process is applied in the reducing step; and
a binarizing step that executes a binarizing process on a pixel in the image on which the reducing process is applied in the reducing step on the basis of the histogram generated in the histogram generating step.

16. The image processing program according to claim 15, comprising an area discriminating step for discriminating a pixel area of a uniform density having a thickness equal to or larger than a predetermined value in the image in the image data on the basis of the image binarized in the binarizing step.

17. The image processing program according to claim 15, wherein the binarizing step divides the histogram generated in the histogram generating step into at least two density segments, selects at least one of the predetermined threshold value on the basis of a frequency of usage of color contents in the respective segments, and executes the binarizing process for the pixel in the image on which the reducing process is applied in the reducing step.

18. The image processing program according to claim 16 comprising:
an edge detecting step that executes an edge detecting process for detecting edge strength on the image in the image data as the target of processing; and
an image type discriminating step for discriminating an image type of the pixel area of a uniform density having a thickness equal to or larger than the predetermined value in the image in the image data on the basis of a result of discrimination in the area discriminating step and a result detected in the edge detecting step.

19. The image processing program according to claim 18, comprising a filter selecting step for selecting a type of filtering process to be applied to the pixel area for the respective image types on the basis of the image type discriminated in the image type discriminating step.

20. The image processing program according to claim 16 comprising:
an edge detecting step that apples an edge detecting process for detecting edge strength on the image in the image data as the target of processing; and
a line-thinning step that executes a line-thinning process for the pixels detected as pixels that form an outline of the pixel area of a uniform density in the edge detecting step out of the pixels that are discriminated in the area discriminating step to be those that constitute the pixel area of a uniform density having a thickness equal to or larger than the predetermined value in the image in the image data.
